(19) United States
(12) Patent Application Publication
(10) Pub. No.: US 2017/0321458 A1
(43) Pub. Date: Nov. 9, 2017

(54) AUTOMATIC STOP FOR DOORS AND WINDOW SHUTTERS PROVIDED WITH ADJUSTABLE STRUCTURE

(71) Applicant: ESINPLAST - S.R.L., Monsano (AN) (IT)

(72) Inventor: Alessandro CIRILLI, Jesi (AN) (IT)

(21) Appl. No.: 15/527,433

(22) PCT Filed: Jan. 22, 2015
(86) PCT No.: PCT/IT2015/000011

§ 371 Date: May 17, 2017

(30) Foreign Application Priority Data
Dec. 3, 2014 (IT) AN2014U000085

(51) Int. Cl. E05C 17/50; E05B 15/00; E05B 15/04

(52) U.S. Cl. CPC E05C 17/50; E05B 15/0053; E05B 2015/0458

(57) ABSTRACT

Automatic stop used to stop doors and window shutters in the fully open position, wherein the stop is fixed to the wall of a building by a revolving arm in order to alternatively be in an operating position, perpendicularly protruding from the wall, and in a resting position, wherein it is in parallel position close to the wall.

The present patent application relates to an automatic stop for doors and window shutters provided with adjustable structure.

The peculiarities and advantages of the invention will become evident after a short description of the prior art.

As it is known, automatic stops for doors and window shutters, which are specifically designed to automatically catch doors and window shutters when they are opened in full and stably lock them in such a position, have for years existed on the market.

In view of the above, when they are in fully open position on the external wall of a building, the doors or window shutters are not exposed to the thrust of strong winds that may cause their rotation and uncontrolled impact.

When they are used to stop the shutters of a window, the stops of the prior art are fixed on the outside of the building, at the sides of the window, in perpendicular position to the installation wall.

Instead, when they are used to stop the doors of a building, the stops of the prior art are installed on an external wall (if they have to cooperate with an external door providing access to the building) or an internal wall (if they have to to cooperate with an internal door provided between two areas of the same building).

In view of the above, each stop is provided with a horizontal arm adapted to be fixed and screwed onto the installation wall.

An oscillating hook is mounted on the front of a similar horizontal wall, it being adapted to suffer the interference of the lower horizontal edge of the shutter when the latter is in fully open position, in which it is disposed at a short distance from the wall of the building in substantially parallel position.

Practically, the interference of the shutter actuates the oscillating hook, which automatically catches a section of the edge of the shutter (preferably one of its horizontal edges), thus preventing the latter from rotating.

The shutter will recover its normal capability of rotating towards its closing position only after the user has released the oscillating hook manually.

The following description illustrates in detail the structure and the operating mode adopted in the window shutter stop of the invention.

It must be noted that, in spite of being practically effective, the prior art as described in general terms above is impaired by a remarkable drawback.

Reference is made to the fact that all traditional window shutter stops permanently projects on the front of the installation wall.

It is easy to understand that such a presence is not desirable, especially when the doors or windows are closed, in such a condition that the provision of the shutter stops on the front of the building wall is immediately visible (on the contrary, when the doors or windows are open, the presence of the shutter stops is somehow “camouflaged”).

In fact, such a visible presence of the shutter stops impairs the general aesthetics of the building, especially in case of buildings of great value. Moreover, the shutter stops may be a risk for personal safety when they are installed on the building at a walkable height.

In such a case, a person distractedly walking along the wall of the building may accidentally bump into the shutter stops that project from the front of the wall.

In view of such a critical consideration, the specific purpose of the present invention is to devise a stop for doors and window shutters provided with adjustable structure, which is adapted to be in two different positions on the front of the wall according to its specific use, i.e. to lock a door or a window shutter in fully open position or to remain idle because the door or the window shutter is closed.

The inventive idea that has allowed for achieving such a specific purpose is the creation of a shutter stop provided with a supporting arm adapted to rotate “as a flag” with respect to a plate used for fixing on the front of the building wall.

The provision of a similar revolving arm allows the new stop of the invention to alternatively be in normal operating position, in which it protrudes perpendicularly on the front of the wall, and in resting position, in which it is disposed in parallel position close to the wall after rotating the supporting arm by approximately 90°.

Evidently, when in operating position, the stop of the invention is adapted to automatically catch the edge of a door or a window at the end of its opening travel.

It is equally understood that, when in resting position, the stop of the invention exponentially reduces its volume on the front of the wall, in such manner not to be a dangerous hindrance for a person walking along the wall where the stop is mounted.

An additional purpose of the present invention is to allow the stop of the invention, and more specifically its horizontal supporting arm, to stably maintain its operating position and its resting position, in such manner that only the energetic manual action of the user can make the supporting arm go from one position to another.

For explanatory reasons the description of the invention continues with reference to the attached drawings, which only have an illustrative, non-limiting value, wherein:

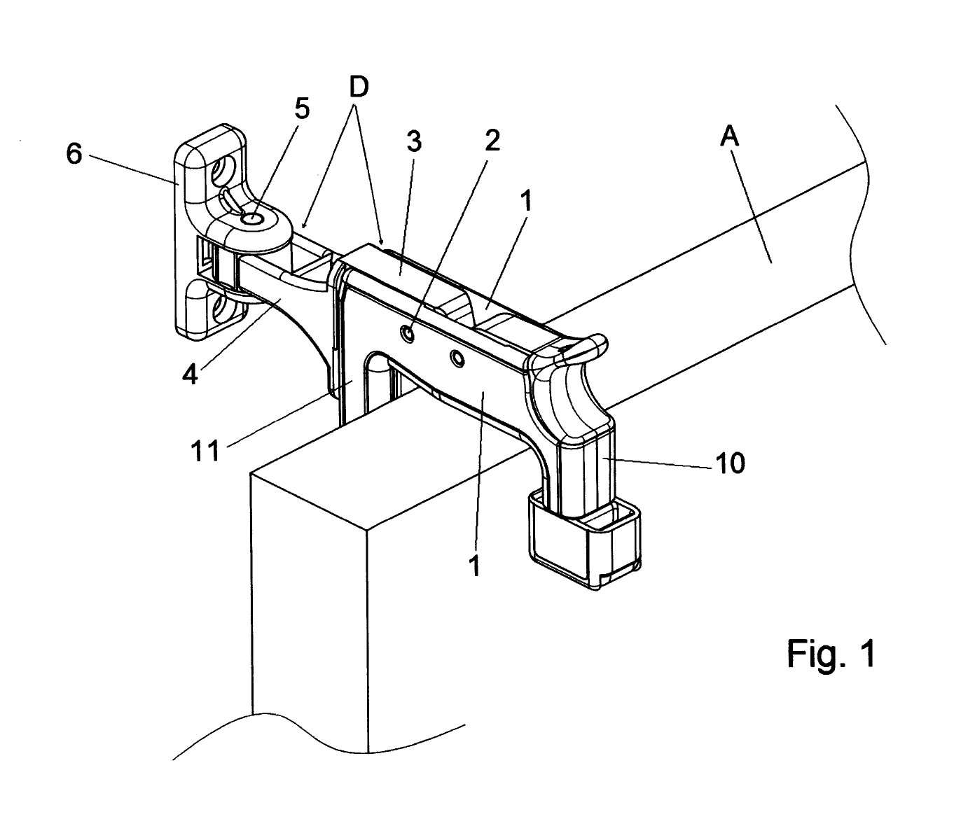

FIG. 1 is an axonometric view of the new stop of the invention in operating position, when it protrudes perpendicularly from the fixing wall;

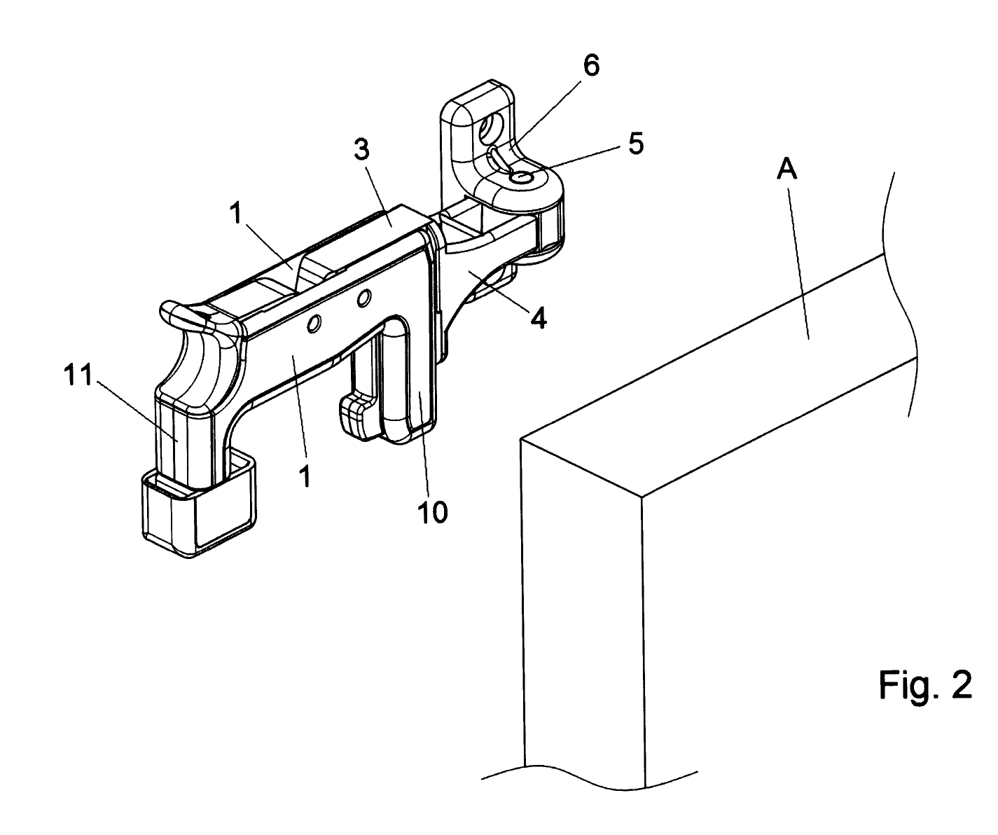

FIG. 2 is a view of the same stop in resting position, when it is in parallel position close to the fixing wall;

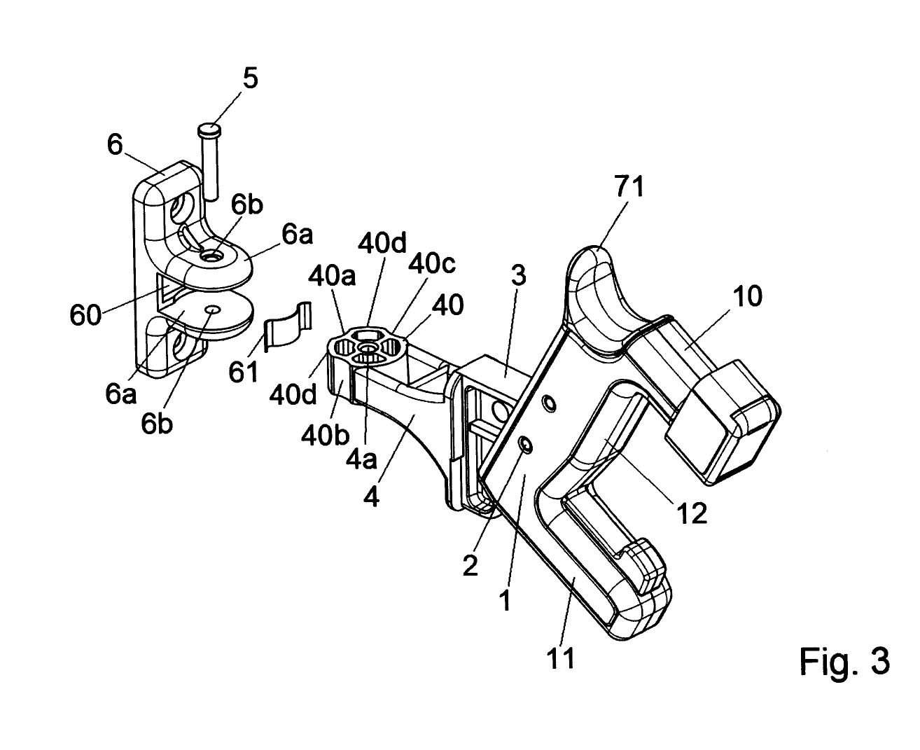

FIG. 3 is a partially exploded axonometric view of the shutter stop of the invention;

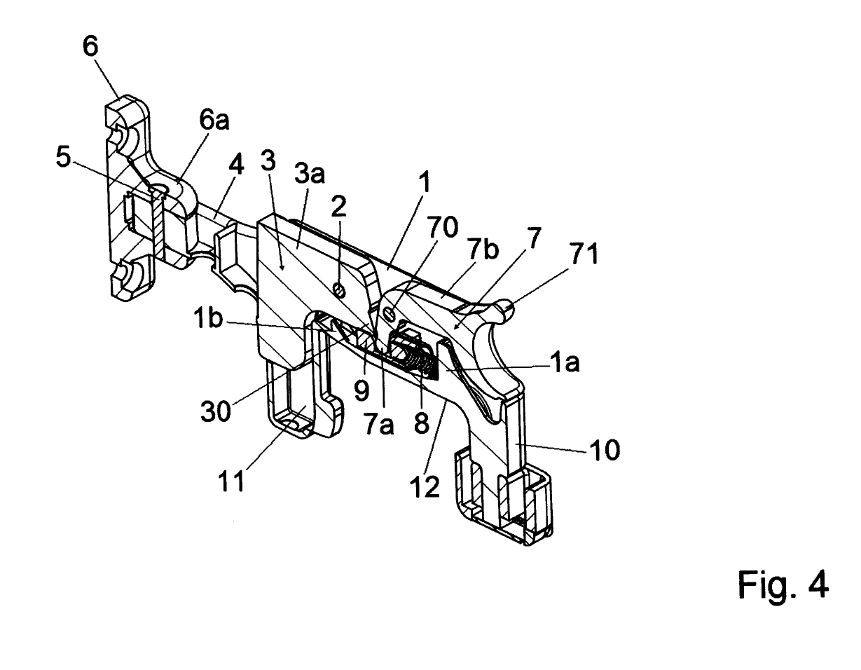

FIG. 4 is an axonometric sectional view obtained with a longitudinal plane of the internal structure of the shutter stop of the invention when the oscillating hook is in operating position;

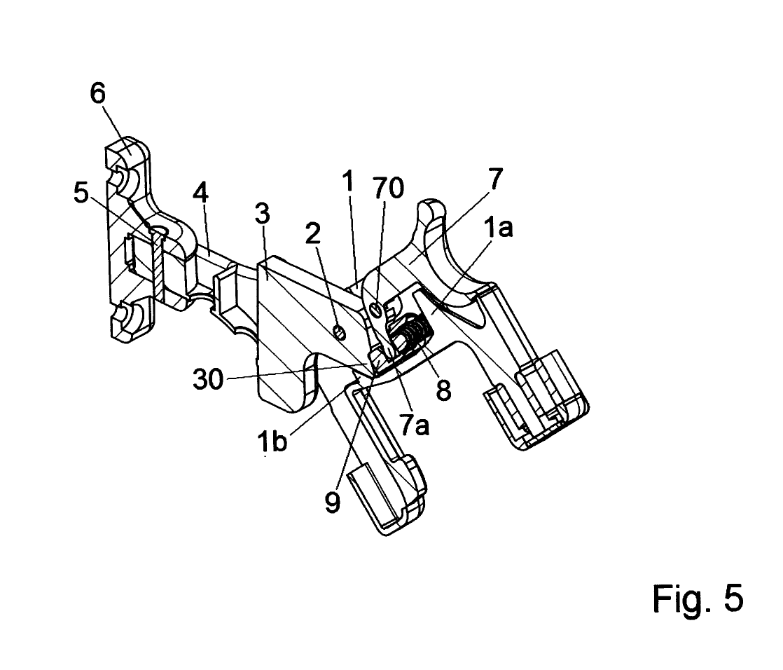

FIG. 5 is an axonometric sectional view obtained with a longitudinal plane of the internal structure of the shutter stop of the invention when the oscillating hook is in resting position;

With reference to the aforementioned figures, the stop for doors and window shutters (D)—the components of which are obtained from molding suitable plastic materials—is provided with an oscillating box-shaped hook (1) that is pivoted, with respect to a pin with horizontal axis (2), to a square (3) provided in edgewise position at the end of a horizontal arm (4).

The function of the oscillating hook (1) is to automatically catch the edge of a shutter (A) in fully open position, whereas the function of the arm (4) is to support the hook (1), and ultimately the entire shutter stop (D) on the front of a building wall.

Moreover, the arm (4) is pivoted with respect to a pin with vertical axis (5) to a plate (6) adapted to be screwed onto the vertical wall of the building where the stop (D) is installed.

The pivoting coupling allows the arm (4) to rotate “as a flag” with respect to the plate (6) fixed to the wall.

In fact, because of the inverse rotations of the supporting arm (4), the stop of the invention (D) can be alternatively brought from the operating position shown in FIG. 1 (in which it protrudes perpendicularly from the wall) to the resting position shown in FIG. 2 (wherein it is parallel and very close to the wall).

In particular, FIG. 1 shows the stop of the invention (D) when it catches the upper horizontal edge of a door (A) in its preferential use.

With reference to the pivoting coupling of the supporting arm (4) with the plate (6), the plate (6) is frontally provided with a pair of wings (6a) disposed in exactly overlapped position and provided with a central hole with vertical axis (6b).

The two wings (6a) are adapted to exactly receive the back end of the arm (4), which is in turn provided with a hole with vertical axis (4a) adapted to be disposed in perfect alignment with the two holes (6b) of the plate (6).

In view of the above, as shown in the exploded drawing of FIG. 3, the three holes (6b, 4a) simultaneously receive the pivoting pin with vertical axis (5).

As mentioned above, the revolving arm (4) stably maintains the operating position and the resting position by means of a special “snap-in” coupling with the plate (6).

As shown in FIG. 3, the back end of the revolving arm (4) practically consists in a grooved disk (40) that is centrally provided with said hole with vertical axis (4a).

More precisely, the disk (40) is provided with three identical grooves with vertical axis (40a, 40b, 40c), with a substantially circular shape, the first groove (40a) laying on the symmetrical longitudinal axis of the revolving arm (4), whereas the other two grooves (40b, 40c) are faced in symmetrically opposite position onto the two sides of the arm (4), being angularly spaced by approximately 90° with respect to the first groove (40a).

The plate (6) is provided on the front side, in intermediate position between the wings (6a), with a substantially rectangular horizontal housing (60) adapted to house a leaf spring (61) provided with a central loop adapted to be snapped-in inside either one of the grooves (40a, 40b, 40c) of the back disk (40) of the revolving arm (4).

As a matter of fact, until the arm (4) is not in the projecting position of FIG. 1, the spring (61a) is exactly and energetically inserted into the central groove (40a).

Such an energetic coupling prevents the arm (4) from rotating freely with respect to the plate (6) in such manner that only the manual action of the user causing a 90° rotation of the arm (4) can allow for extracting the spring (61) from the central groove (40a).

In particular, such an effect is due to the compression suffered by the spring (61) because of the interference generated against it by either one of the two non-grooved sections, comparable to two corners (40d), adopted by the disk (40) in intermediate positions between the three grooves (40a, 40b, 40c).

When the user has completed the 90° lateral rotation of the revolving arm (4), the spring (61) expands again towards the front, having lost the interference with either one of the corners (40d) of the disk (40) and being perfectly aligned with either lateral groove (40b, 40c), instantaneously snapping into the lateral groove (40b, 40c) disposed in front of it.

Also in this case, such a snap-in coupling produces the stabilization of the proximal parallel position reached by the arm (4) with respect to the wall of the building, thus maintaining the stop of the invention (D) in resting position.

With reference to the three aforementioned figures, it must be noted that the oscillating hook (1) is alternatively brought into two operation positions, rotating with respect to said pin with horizontal axis (2), with respect to the square (3) provided at the end of the revolving arm (4).

More precisely, FIGS. 1 and 2 show the hook (1) in a substantially horizontal operating position, in which the two parallel horns (10, 11) are lowered from opposite sides onto the edge of the shutter (A), whereas FIGS. 3 and 4 show the hook (1) in an upwards-tilted resting position, in which the hook (1) is still waiting for the interference with the edge of the shutter (A).

For a description of the structure and of the operation mode of the oscillating hook (2) reference is made to FIGS. 4 and 5.

With reference to these figures, it must be noted that the box-shaped oscillating hook (1) is provided with two horns (10, 11) joined by a longitudinal wall (12) that is substantially perpendicular to the horns (10, 11).

As shown in these figures, the hook (1) is pivoted to the horizontal wing (3a) of the square (3) by means of the pin with horizontal axis (2).

Moreover, it must be noted that the square (3) is provided at the lower-front end of the horizontal wing (3a) with a pointed striker (30) provided with a sloping front wall.

The box structure of the oscillating hook (1) houses an L-shaped oscillating lever (7) mounted with the vertical wing (7a) faced downwards and subject to the action of a spring (8) fixed between said vertical wing (7a) and a fixed projection (1a) provided inside the oscillating hook (1).

In particular, the lever (7) is pivoted with respect to a pin with horizontal axis (70) in parallel position to the pivoting pin (2) provided between the square (3) and the entire oscillating hook (1).

A trigger (71) is obtained at the end of the horizontal wing (7b) of the lever (7), protruding from the oscillating hook (1) at the front end above the first horn (10).

The lower end of the vertical wing (7a) of the lever (7) is associated with a slider (9) that basically consists in a parallelepiped block and is adapted to alternatively slide on the internal side of the longitudinal wall (12) of the hook (1), i.e. the one joining the two horns (10, 11) in the oscillating hook (1).

Referring to FIG. 6, when the hook (1) is tilted upwards, the lever (7) is entirely housed inside the structure of the hook (1) in such manner that the first end of the slider (9) is engaged against the sloping wall of the striker (30) of the square (3).

Moreover, FIG. 6 shows that the upward rotation of the hook (1) is stopped when a counter-striker (1b) protruding from the longitudinal wall (12) in proximity to the second horn (11) is stopped against the lower surface of the striker (30) of the square (3).

As mentioned above, when the hook (1) is in tilted position, the shutter stop of the invention (D) is not in operating position; it can be otherwise said that it is ready to automatically catch the edge of the shutter (A) interfering with it in fully open position.

In such a case, more precisely, the edge of the shutter (A) interferes with the second horn (11) of the hook (1) without having interfered with the first horn (10) that is disposed at a higher height—which is not reached by the edge of the shutter—in view of the upward inclination of the hook (1).

A similar interface of the shutter (A) against the second horn (11) makes the hook (1) oscillate downwards, so that the ends of the two horns (10, 11) are substantially disposed at the same height—as shown in FIG. 4—and in such a condition that the first horn (10) is disposed on the front of the shutter (A) and the second horn (11) is disposed on the back of the shutter (A), thus blocking the shutter (A) between them, as shown in FIG. 1.

As shown in FIG. 4, during a similar downward oscillation of the hook (1), the slider (9) moves shortly forward and passes over the striker (30) of the square (3) because of the return action of the spring (8), it being exactly disposed between the internal side of the longitudinal wall (12) of the hook (1) and the lower rectilinear surface of the striker (5).

The position of the slider (9), which acts as a shim, prevents the hook (1) from rotating freely (and accidentally) upwards, thus undesirably releasing the hook (1) with respect to the edge of the shutter (A).

In order to release the hook (1), and consequently the shutter (A), the operator must actuate the trigger (71) overcoming the opposition force exerted by the spring (8) against the vertical wing (7a) of the L-shaped lever (7).

Such an activity favors the forward travel of the slider (9), thus entirely releasing it from the lower rectilinear surface of the striker (30) of the square (3), losing its function as a shim and making it possible to incline the entire hook (1) again upwards.

1. An automatic stop for doors and window shutters provided with an oscillating hook adapted to be fixed to a wall of a building by means of a horizontal supporting arm in order to automatically catch an edge of a shutter when the shutter is in fully open position, wherein said horizontal supporting arm is adapted to rotate as a flag, said horizontal supporting arm being pivoted by means of a vertical pin with respect to a plate fixed on the front of the wall of the building; wherein said horizontal supporting arm is adapted to alternatively go from a perpendicular position with respect to the wall of the building to a parallel position close to the wall, further to an 90° rotation.

2. The stop of claim 1, wherein said plate is frontally provided with two horizontal wings, each horizontal wing having a central hole and wherein the horizontal supporting arm is provided with a back end adapted to be exactly engaged between the two horizontal wings of the plate, and with a hole with vertical axis adapted to be perfectly aligned with the two holes of the horizontal wings in such manner that the holes of the horizontal wings and the hole of the horizontal supporting arm are simultaneously penetrated by the vertical pin.

3. The stop of claim 2, wherein the horizontal supporting arm and the plate are provided with stopping elements adapted to maintain the arm in an operating position stably.

4. The stop of claim 3, wherein the stopping elements provided in the horizontal supporting arm and in the plate comprise:
a horizontal disk provided in a back end of the horizontal supporting arm, said horizontal disk being centrally crossed by the hole of the horizontal supporting arm; wherein said disk is provided with a first, a second and a third circular grooves with vertical axis, the first groove lays on a longitudinal axis of the horizontal supporting arm, and the second and third grooves are faced in symmetrically opposite position onto two sides of the horizontal supporting arm, angularly spaced by approximately 90°, and wherein a corner is provided between the first groove and the second groove and between the first groove and the third groove, and
a leaf spring engaged into a rectangular horizontal housing provided in intermediate position between the two horizontal wings, wherein said leaf spring is adapted to forcedly penetrate into either one of the first, second and third grooves of the disk, when the leaf spring and each groove are perfectly aligned.

5. The stop of claim 1, wherein:
the horizontal supporting arm incorporates a square in edgewise position at the front end of the horizontal supporting arm, whereon the oscillating hook is pivoted, by means of a horizontal pivoting pin with horizontal axis passing through an end of a horizontal wing of said square; wherein said oscillating hook is adapted to alternatively go from an operating position, in which the oscillating hook is in axis with the horizontal supporting arm, to an resting position, in which the oscillating hook is tilted with respect to the horizontal supporting arm;
the oscillating hook has two parallel horns joined by a longitudinal wall substantially perpendicular to said horns;
the square is provided on a lower-front end with a striker having a sloping front wall;
the oscillating hook is internally provided with an L-shaped lever comprising a horizontal wing and a vertical wing; said lever being pivoted by means of a pin with horizontal axis parallel to the horizontal pivoting pin between the square and the oscillating hook, wherein said lever is provided in a front end of its horizontal wing with a trigger that protrudes from the oscillating hook;
the vertical wing of the lever is hooked to a first end of a spring hooked at a second end with a fixed projection that internally protrudes from a longitudinal wall of the oscillating hook; wherein an end of said vertical wing of the lever is associated with a slider consisting in a parallelepiped block, adapted to alternatively slide above the longitudinal wall of the oscillating hook, and said slider be inserted under a lower rectilinear surface of the striker when the oscillating hook maintains an operating position, substantially in axis with the arm;
the trigger is adapted to generate the rotation of the lever with respect to the pin with horizontal axis, further to which an end of the vertical wing of the lever overcomes a opposite thrust of the spring and moves the slider in such manner to release it from the striker, thus bringing the oscillating hook to its operating position, in tilted position with respect to the horizontal supporting arm;
the longitudinal wall of the oscillating hook is internally provided, in proximity to a second horn, with a counter-striker adapted to interfere with the lower rectilinear surface of the striker when the oscillating hook reaches its tilted resting position.
